(19) United States
(12) Patent Application Publication
(10) Pub. No.: US 2011/0143008 A1
(43) Pub. Date: Jun. 16, 2011

(54) Frozen Slush Drink

(76) Inventor: David Mattie, San Diego, CA (US)

(21) Appl. No.: 13/030,996

(22) Filed: Feb. 18, 2011

Related U.S. Application Data
(63) Continuation-in-part of application No. 11/867,204, filed on Oct. 4, 2007.

(51) Int. Cl. A23L 2/52

(52) U.S. Cl. 426/565

(57) ABSTRACT

A new formulation for frozen slush, flavored drinks is presented. A formulation has been found that will allow the formulation of tea, herbs or other plant extract based frozen slush drinks. The formulation is stable to freezing and thawing. The drink may be locally made and immediately consumed and also may be made using centralized controlled manufacturing and distribution of the finished product. A manufacturing process is also provided.

### CROSS-REFERENCE TO RELATED APPLICATIONS

This application is a continuation-in-part of application Ser. No. 11/867,204 filed 4 Oct. 2007.

### TECHNICAL FIELD

The present invention relates to formulations for frozen slush drinks containing teas, herbs and generally plant extracts and processes to make them.

### BACKGROUND OF THE INVENTION

Frozen slush drinks are very popular within the US and throughout the world. Frozen slush coffee drinks and frozen slush fruit drinks are the most commercially successful examples. Properties of the drinks that are important to the success are the flavor, the consistency of the flavor throughout the time of consumption, the texture or feel of the drink in the mouth, the appearance of the drink and the perception of the drinks being prepared from healthful constituents. Coffee flavored frozen slush drinks are typically produced from dispersant concentrates that are mixed with coffee just before the time of sale. Commercially available mixing and freezing machines blend the mix, lower the temperature below a freeze point and mix air into the mix to create a slush. The drink is then sold for immediate consumption. Because the slush mixture is generally not stable to freeze thaw cycles, the drink is not stored or subjected to a thaw cycle prior to consumption. Current products require mixing and consumption within a short, up to about one hour, time frame. Similarly there are commercial endeavors that provide blends of fruits that are mixed with ice and blended at high speeds to produce a slush drink. Here to the drink is typically prepared just prior to consumption. A motive for these preparation methods is that the slush formulations are typically not stable. Storage of the finished formulation often results in flavor loss, separation of components resulting in layers of the drink that have different components and therefore different flavors. The consumer when drinking will taste layers where the flavoring is too strong and layers where the flavor is too weak or even distasteful. Similarly the texture or feel of the drink can change from pleasant to unpleasant in layers on separation. The appearance may change from a uniform lightly frothed texture to separate layers and precipitation of components. Often the stabilizers added to allow creation of a foam drink will separate into a top layer creating an effect called creaming. Currently, short-term instability is addressed through additives and the method of marketing. The inventor knows of no formulations that are stable to freeze thaw cycles or otherwise allow long-term storage. There is a need for formulations that can be prepared in advance and stored prior to sale and consumption.

Surprisingly, there are few such slush drinks prepared using teas and extracts of herbs and other plants. It has been found to be much more difficult to produce a stable tea or herbal plant extract formulation that could be slushed and consumed, even if the consumption is immediate. Producing a frozen slush drink based upon teas or herbal extracts that may be stored, frozen and thawed is even more difficult. There is a commercial demand for slush drinks prepared with teas and herbal extracts, however none have been successfully developed until this invention.

The theories related to foam stability would indicate that subtle differences between a coffee and tea based drink may prove to be substantial when considering foam stability. Slight changes in electrolytes, charges on dispersed particulate and hydrophile-lipophile balances in the formulation all can result in catastrophic changes to the stability of a foam or slush drink. As used here the drinks described contain a significant amount of air entrainment and are therefore a foam that is frozen to a slush consistency. Through the remainder of the descriptions the terms slush and foam are used interchangeably and should be understood to imply a frozen foam drink with a consistency of slush. Although there is much theory, in practice developing a stable slush drink formulation is most often an empirical exercise. Discovering the right combination of surfactants, flavorings and other components that produces a stable formulation is often a long term hit or miss exercise. Subtle changes in ingredients or combinations of ingredients can produce widely varying results. Discovery of a formulation that produces a stable slush drink requires persistent trial and error experimentation.

### SUMMARY OF THE INVENTION

A formulation for tea and herbal extracts flavored frozen slush drinks is reported. The formulations are not only usable with tea and herbal extract drinks for immediate consumption, but unlike previous formulation the formulation is stable to frozen storage. The drink is mixed and a slush is formed which may then be consumed immediately or further frozen for long-term shelf life. The drink is then stable to thawing resulting in a thawed frozen slush drink that will melt uniformly while being consumed without separation of components or collapse of the foam. As used here the drinks described contain a significant amount of air entrainment and are therefore a foam that is frozen to a slush consistency. Through the remainder of the descriptions the terms slush and foam are used interchangeably and should be understood to imply a frozen foam drink with a consistency of slush. The formulation is prepared with a unique combination of dispersant agents fortuitously discovered to provide the unusual stability even through freeze thaw cycles. The formulation may therefore be prepared in advanced and stored until time of sale and consumption.

In another embodiment a process for the preparation of a frozen slush drink is provided. The process enables centralized manufacturing, distribution and eventual sale to the consumer.

### BRIEF DESCRIPTION OF THE DRAWINGS

FIG. 1 is a flow chart for a preparation process embodiment of the invention.

### DETAILED DESCRIPTION

Embodiments of the invention provide formulations for the preparation of a stable frozen slush drink and processes to prepare the drink. The formulation includes water, stabilizers in the form of gums, sedimentation stabilizers such as carboxymethylcellulose and sugars which act as both emulsifiers and sweeteners, primarily consisting of glucose, fructose smaller amounts of higher sugars. In one embodiment there is approximately 90% by weight water, 7% by weight sugars, 1% by weight carboxymethylcellulose and 1% by weight gums. In another embodiment honey is used to provide some of the glucose and flavoring. There are also trace (less than 0.1%) amounts of minerals, vitamins and higher sugars present if honey is used as a sweetener or additive. In another embodiment there is 2 to 10% sugar, 0.1 to 1.0% carboxymethylcellulose and 0.5 to 3% gum and the remainder water. In a preferred embodiment there is approximately 90% by weight water, 6% by weight honey, 1% by weight glucose, 0.5% by weight carboxymethylcellulose, 0.5% by weight of guar gum, 0.5% by weight locust bean gum and 0.3% by weight xanthan gum.

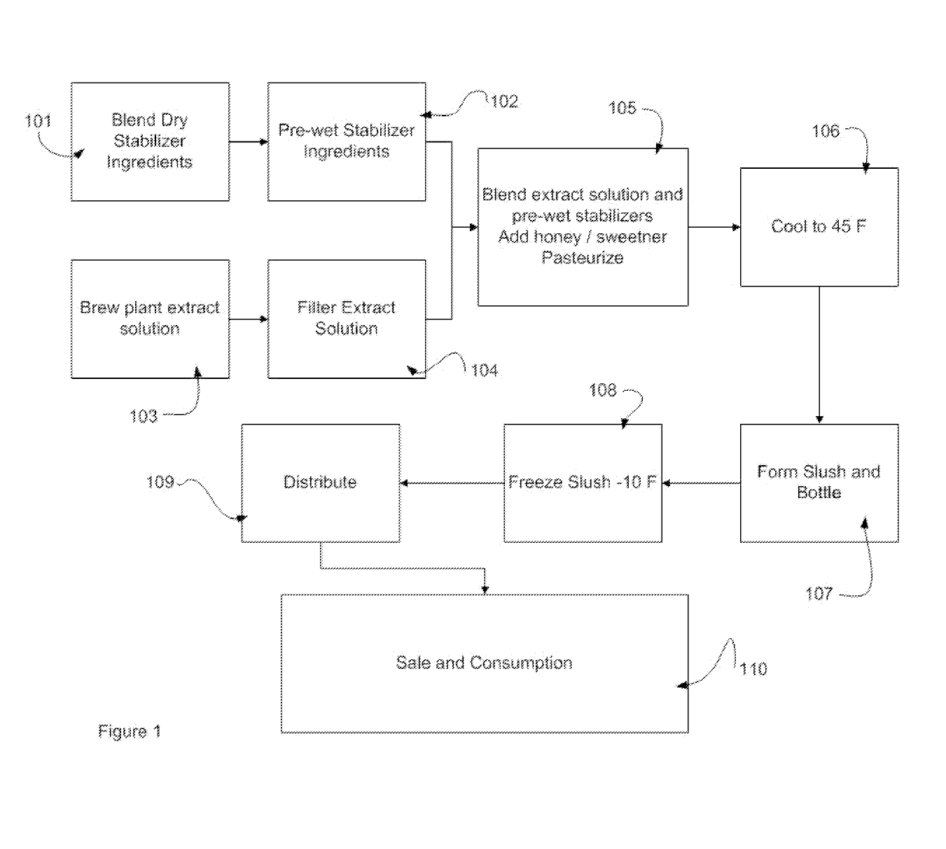

Successful preparation of the invented drink requires attention to the processing of the components. It has been discovered that best results are obtained by first preparing a pre-mix of the stabilizer gums. The glucose and carboxymethylcellulose blended with the gums act to create a blend of the stabilizer gums that can later be added to the primarily water containing components that will blend to create a mixture that may be foamed in frozen slush making machine and then bottled frozen and distributed for sale. Incomplete addition of any of the gums results in a drink that is deficient in some aspect of stability, uniform flavor, texture or shelf life. A preferred embodiment of the invention is diagrammed in FIG. 1. The proportion of the various ingredients is shown in Table 1. Based upon known typical composition of honey the composition may be equivalently described as shown in Table 2.

TABLE 1

| Ingredient | Percent by Weight |
|---|---|
| Water | 90.1% |
| Honey | 6.6 |
| Glucose | 1.3 |
| Carboxymethylcellulose | 0.6 |
| Guar Gum | 0.6 |
| Xanthan Gum | 0.3 |
| Locust Bean Gum | 0.6 |

TABLE 2

| Ingredient | Percent by Weight |
|---|---|
| Water | 91.0% |
| Glucose, sucrose, fructose, maltose and | 6.7 |
| higher sugars | |
| Carboxymethylcellulose | 0.6 |
| Guar Gum | 0.6 |
| Xanthan Gum | 0.3 |
| Locust Bean Gum | 0.6 |

The process begins with the blending 101 of the stabilizer ingredients. The glucose, separate from that in the honey, guar gum, locust bean gum, xanthan gum and the carboxymethylcellulose are blended together as dry ingredients. The blended stabilizer ingredients are then pre-wet 102 using 10% of the total water volume to be used in the recipe. In a parallel path the flavoring extract is brewed 103 by making a 1% by weight blend of the plant parts with 90% of the total water content to be used in the formulation. The extract mix is heated up to about 212 F and held for approximately 5 minutes. Variations in the plant to be extracted may require variations in the extract heating temperature. It is then filtered or strained 104 just sufficiently to remove visible solids of the leaves or other plant parts. The resultant extract solution is then blended 105 with the pre-wet stabilizer mix; honey or other sweeteners are added. The solution is now pasteurized at 185 F for 10 minutes. Following pasteurization, the solution is cooled to 45 F 106 prior to introduction into the slush machine. The slush is formed and bottled 107 using a soft serve machine as known in the industry. Machines used have been similar to those, for example, made by Taylor® manufacturing. The slush is formed with up to 25% by volume air entrainment. The drink may then be immediately consumed. Alternatively the slush is frozen 108 at approximately −10 F. It is distributed 109 under refrigerated conditions for eventual sale and consumption 110.

In a preferred embodiment the plant flavor extract solution was produced by extracting flavor through the brewing process from peppermint leaves. In another embodiment green tea leaves are used in the brewing process. In another embodiment teas are selected from any one of green, black, or peppermint leaves are used. In yet another embodiment herbs are used to prepare the extract solution. As used here, herbs may be any plant whose roots, stems, leaves, flowers or seeds may be extracted to produce a consumable drink.

### EXAMPLES

A set of experimental formulations including the preferred formulation were prepared and tested for taste, uniformity of taste through the time of consumption, appearance, mouth feel, the ability to form a slush or foam and the stability of the resultant slush. The experimental formulations varied in the removal of one or more gum components from the preferred formulation, while keeping the total content of the gums (by weight) constant, except for one experimental formulation. The list of the experimental formulations is shown in Table 3. The preparation process for each of the experimental formulations was as described above and diagrammed in FIG. 1.

TABLE 3

| | Experimental Formulations | | | | | | | | |
|---|---|---|---|---|---|---|---|---|---|
| | All values are percentage by weight | | | | | | | | |
| Component | A | B | C | D | E | F | G | H | I |
| Water | 90.1 | 90.1 | 90.1 | 90.1 | 90.1 | 90.1 | 90.1 | 90.1 | 90.1 |
| Sugars | 6.6 | 6.6 | 6.6 | 6.6 | 6.6 | 6.6 | 6.6 | 6.6 | 6.6 |
| Carboxymethylcellulose | 0.6 | 0.6 | 0.6 | 0.6 | 0.6 | 0.6 | 0.6 | 0.6 | 0.6 |
| Guar Gum | 0.6 | 0.8 | 0.8 | 0 | 0.6 | 0.6 | 0 | 0 | 1.4 |
| Xanthan Gum | 0.3 | 0 | 0.6 | 0.6 | 0 | 0.4 | 1.4 | 0 | 0 |
| Locust Bean Gum | 0.6 | 0.6 | 0 | 0.8 | 0.8 | 0.6 | 0 | 1.4 | 0 |

Formulation A is the preferred formulation. It was judged to have good sweetness and taste otherwise. The taste remained uniform during consumption the drink looked uniform and had a smooth feel in the mouth. The formulation did in fact easily form a consistently stable slush or foam in the soft serve machine incorporating up to about 25% by volume air into the drink. The drink was stable to a freeze thaw cycle down to −10 F.

Formulation B omitted the Xanthan gum and increased the guar gum to compensate. It resulted in a separation phenomena commonly termed creaming. The slush was not stable for the period required for consumption. Prior to creaming the consistency was judged good. However, the taste of the drink was not consistent top to bottom during consumption, indicating a separation of the components consistent with the occurrence of creaming. Consequently, Formulation B was judged inferior to Formulation A.

Formulation C omitted the locust bean gum and increased the guar gum to compensate, and was less stable in forming the initial foam or slush. The formulation did not consistently form a slush in the soft serve machine and often resulted in forming large ice crystals or simply freezing into a block of ice with no air entrapment to form a slush. The results using formulation C were inconsistent. Some trials of this formulation produced an acceptable foam and others did not, as contrasted with formulation A, which consistently formed a stable foam. Consequently, Formulation C was judged inferior to Formulation A.

Formulation D tested the effect of eliminating the guar gum component while increasing the locust bean gum to compensate, and also exhibited difficulties forming a stable foam. The ingredients seemed to separate in the softserve device producing a layer of hard frozen large ice crystals and a layer of foam but with a freezing point sufficiently lower that it was not completely frozen even while the top layer was frozen solid. Consequently, Formulation D was judged significantly inferior to Formulation A.

Formulation E omitted the xanthan gum, as in Formulation B, but increased the locust bean gum to compensate. The effect was a solution that produced a slush that exhibited a overly coarse texture. Consequently, Formulation E was judged inferior to Formulation A.

Formulation F increased the xanthan gum content by 50%, allowing the total gums content to increase to 1.5%. It produced a slush that exhibited an overly waxy mouth feel when frozen. Consequently, Formulation F was judged inferior to Formulation A.

Formulations G, H and I omitted two of the three candidate gums, thereby retaining a single gum in the experimental composition. Formulation G, containing only xanthan gum, produced a slush having a waxy mouth feel, like composition F. Consequently, Formulation G was judged inferior to Formulation A. Formulations H and I, containing only locust bean and guar gums, respectively, failed to produce foam or slush. Consequently, Formulations H and I were judged significantly inferior to Formulation A.

The conclusion of the examples is that although a tea flavored slush drink may be prepared with an embodiment that leaves out any one of the xanthan, locust bean or guar gums, the most consistently manufacturable formulation having acceptable and stable characteristics uses a combination of all three gums in the amounts shown in Tables 1 and 2, and as Formulation A in Table 3, to produce a freezable, tea flavored slush drink.

### CONCLUSIONS

A new formulation for frozen slush, flavored drinks is presented. A formulation has been found that will allow the formulation of tea, herbs or other plant extract based frozen slush drinks. The formulation is stable to freezing and thawing. The drink may be locally made and immediately consumed and also may be made using centralized controlled manufacturing and distribution of the finished product. A manufacturing process is also provided.

I claim:

1. A frozen slush drink consisting of:
a) water,
b) at least one sugar selected from glucose, sucrose, fructose, maltose and other naturally occurring higher molecular weight sugars,
c) plant extract flavoring,
d) carboxymethylcellulose, and,
e) xanthan gum, guar gum and locust bean gum.

2. The drink of claim 1 wherein the plant extract flavoring is peppermint.

3. The drink of claim 1 wherein the drink consists of 2 to 10% sugar, 0.1 to 1.0% carboxymethylcellulose and 0.5 to 3% gums, and the remainder water, the water containing plant extract flavoring, wherein all percentages are expressed as a weight percent.

4. The drink of claim 1 wherein the plant extract flavoring is flavoring extracted from at least one tea selected from peppermint, black, and green tea.

5. A frozen slush drink consisting, by weight, of:
90.9% water, the water containing plant extract flavoring, and,
7.0% sugar,
0.6% Carboxymethylcellulose,
0.3% guar gum,
0.6% xanthan gum, and,
0.6% locust bean gum.

6. The frozen slush drink of claim 5 wherein the plant extract flavoring is flavoring extracted from at least one tea selected from peppermint, black, and green tea.

7. A frozen slush drink consisting, by weight, of:
90.9% water, the water containing plant extract flavoring, and,
6.0% honey,
1.0% glucose in addition to that naturally occurring in the honey,
0.6% Carboxymethylcellulose,
0.3% guar gum,
0.6% xanthan gum, and,
0.6% locust bean gum.

8. The frozen slush drink of claim 7 wherein the plant extract flavoring is flavoring extracted from at least one tea selected from peppermint, black, and green tea.
